(19) United States
(12) Patent Application Publication
(10) Pub. No.: US 2025/0350058 A1
(43) Pub. Date: Nov. 13, 2025

(54) Electrical Connection Assembly, Electrical Connection Product and Connector

(71) Applicants: Tyco Electronics (Shanghai) Co., Ltd., Shanghai (CN); TE Connectivity Israel Ltd., Ashkelon (IL)

(72) Inventors: Hua (Andy) Li, Shanghai (CN); Wei Yao, Kunshan (CN); Moshe Hai, Herzelia (IL)

(73) Assignees: Tyco Electronics (Shanghai) Co., Ltd., Shanghai (CN); TE Connectivity Israel Ltd., Ashkelon (IL)

(21) Appl. No.: 19/203,866

(22) Filed: May 9, 2025

(30) Foreign Application Priority Data
May 10, 2024 (CN) 202410580988.7

(51) Int. Cl. H01R 12/91

(52) U.S. Cl. CPC H01R 12/91

(57) ABSTRACT

An electrical connection assembly includes an outer conductive shell and an inner conductive body. The outer conductive shell has an annular wall with an upper periphery and a lower periphery axially opposite each other, an elastic part connected to the upper periphery, and a connection part connected to the lower periphery. The inner conductive body is installed in the outer conductive shell and is axially clamped between the elastic part and the connection part. An outer diameter of the inner conductive body is smaller than an inner diameter of the outer conductive shell. The inner conductive body floats axially and radially relative to the outer conductive shell and maintains electrical contact with the outer conductive shell.

### CROSS-REFERENCE TO RELATED APPLICATION

This application claims the benefit of the filing date under 35 U.S.C. § 119 (a)-(d) of Chinese Patent Application No. CN202410580988.7 filed on May 10, 2024.

### FIELD OF THE INVENTION

The present invention relates to an electrical connection assembly and, more particularly, to an electrical connection assembly, an electrical connection product comprising the electrical connection assembly and a connector comprising the electrical connection assembly.

### BACKGROUND OF THE INVENTION

In the prior art, a conductive component in a connector typically cannot float in both axial and radial directions simultaneously. Therefore, the conductive component in the existing connector cannot simultaneously absorb axial and radial errors; consequently, special floating structures need to be installed on the insulation housing of the connector. These floating structures are usually complex and increase manufacturing costs.

### SUMMARY OF THE INVENTION

An electrical connection assembly includes an outer conductive shell and an inner conductive body. The outer conductive shell has an annular wall with an upper periphery and a lower periphery axially opposite each other, an elastic part connected to the upper periphery, and a connection part connected to the lower periphery. The inner conductive body is installed in the outer conductive shell and is axially clamped between the elastic part and the connection part. An outer diameter of the inner conductive body is smaller than an inner diameter of the outer conductive shell. The inner conductive body floats axially and radially relative to the outer conductive shell and maintains electrical contact with the outer conductive shell.

### BRIEF DESCRIPTION OF DRAWINGS

The invention will now be described by way of example with reference to the accompanying figures, of which:

FIG. 1 is a perspective view of an electrical connection assembly and a circuit board according to an exemplary embodiment;

FIG. 2 is an axial sectional view of the electrical connection assembly of FIG. 1 and the circuit board of FIG. 1;

FIG. 3 is a partial exploded axial sectional view of the electrical connection assembly of FIG. 1 and the circuit board of FIG. 1;

FIG. 4 is a perspective view of the electrical connection assembly of FIG. 1;

FIG. 5 is an exploded view of the electrical connection assembly of FIG. 1;

FIG. 6 is an axial sectional view of the electrical connection assembly of FIG. 1;

FIG. 7 is an axial sectional view of an outer conductive shell of the electrical connection assembly of FIG. 1;

FIG. 8 is an axial sectional view of an inner conductive body of the electrical connection assembly of FIG. 1;

FIG. 9 is a perspective view of an elastic contact of the electrical connection assembly of FIG. 1; and

FIG. 10 is an axial sectional view of the electrical connection assembly of FIG. 1, the circuit board of FIG. 1, and a mating plug according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

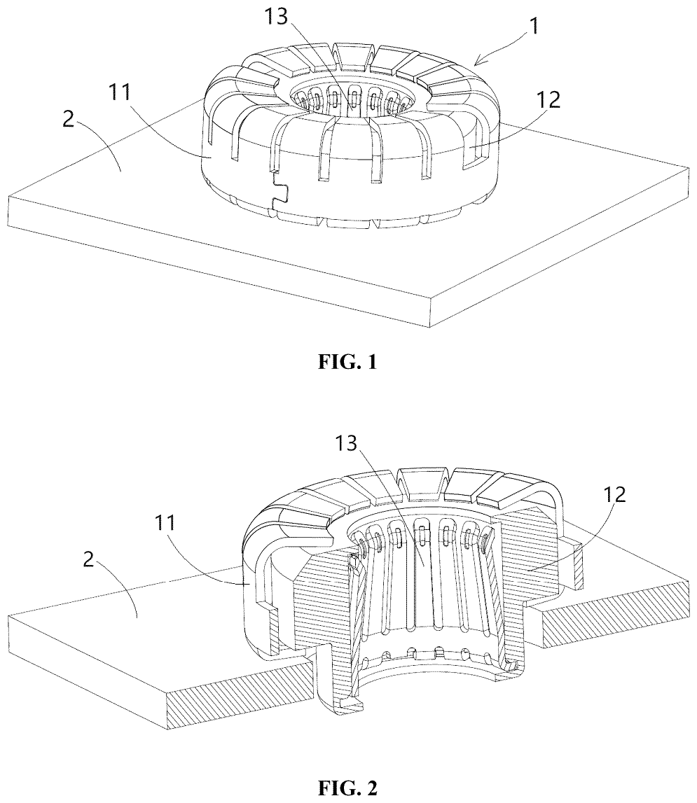

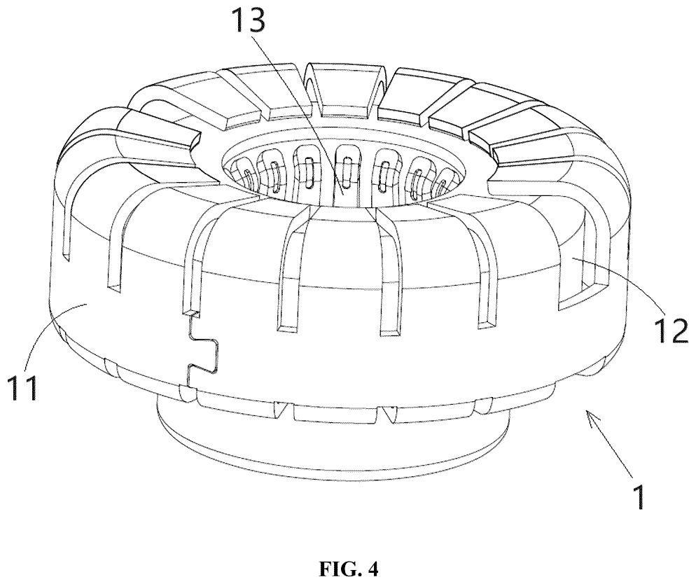

An exemplary embodiment of an electrical connection assembly 1 is now described with reference to FIGS. 1-10. As shown in FIGS. 1-2 and 4, the electrical connection assembly 1 comprises an outer conductive shell 11 and an inner conductive body 12. The inner conductive body 12 is an integral machined part.

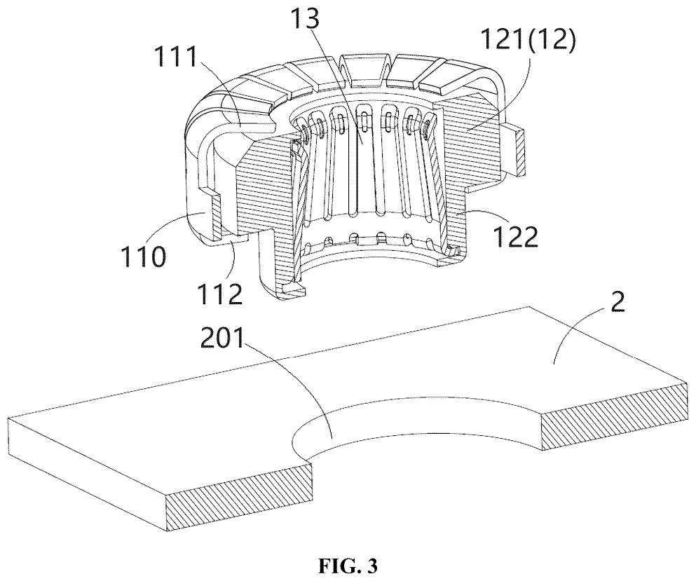

As shown in FIGS. 3 and 6, the outer conductive shell 11 includes an annular wall 110, an elastic part 111, and a connection part 112. The annular wall 110 has axially opposite upper and lower peripheries. The elastic part 111 is connected to the upper periphery of the annular wall 110. The connection part 112 is connected to the lower periphery of the annular wall 110. As shown in FIGS. 2-3, the inner conductive body 12 is installed in the outer conductive shell 11 and is axially clamped between the elastic part 111 and the connection part 112. The outer diameter of the inner conductive body 12 is smaller than the inner diameter of the outer conductive shell 11, allowing the inner conductive body 12 to float axially and radially relative to the outer conductive shell 11 while maintaining electrical contact with it.

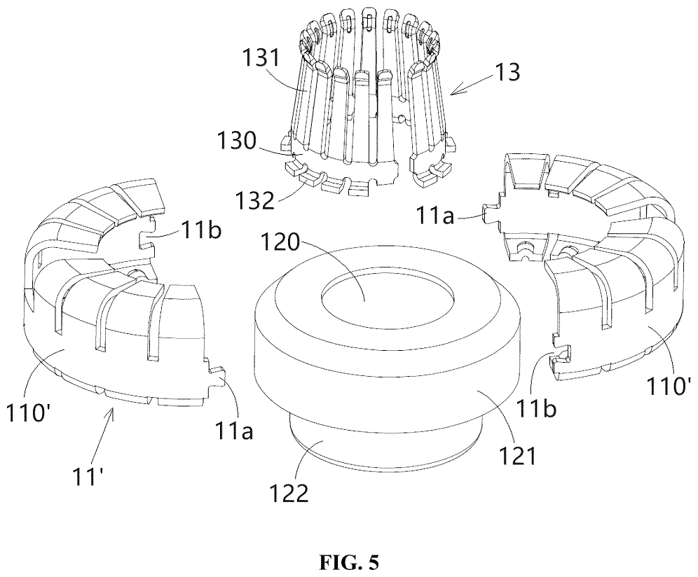

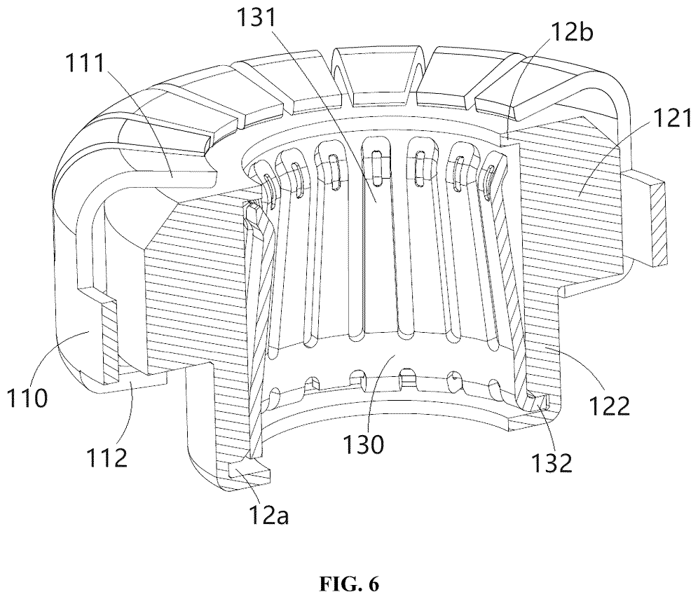

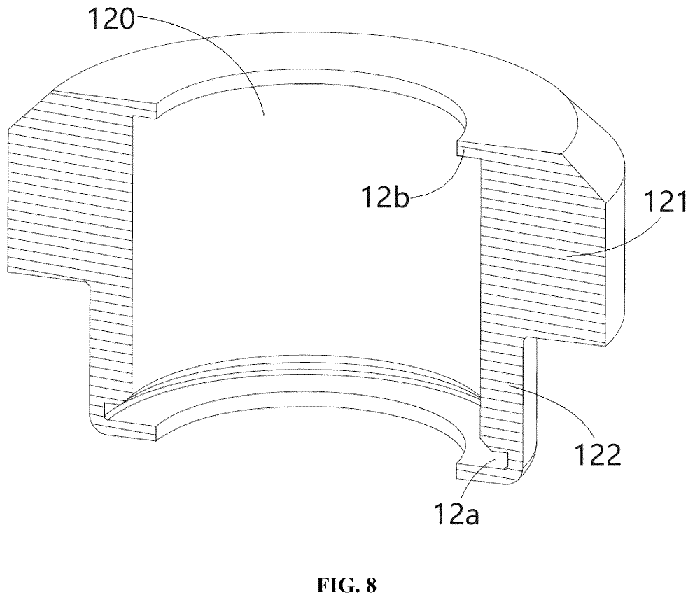

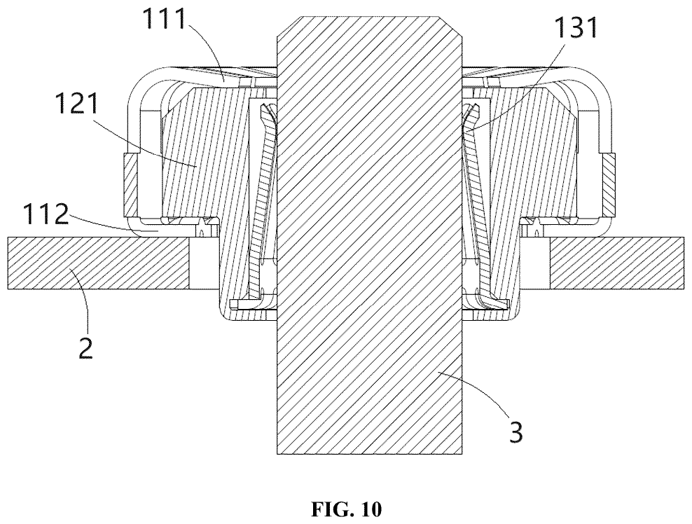

As shown in FIGS. 5 and 8, an inner cavity 120 is formed in the inner conductive body 12 to allow the mating plug 3, as shown in FIG. 10, to be inserted. The electrical connection assembly 1 also includes an elastic contact 13, as shown in FIGS. 1-5, which is installed in the inner cavity 120 of the inner conductive body 12. The elastic contact 13 is used to make electrical contact with the mating plug 3 inserted into the inner cavity 120, so that the mating plug 3 can be electrically connected to the inner conductive body 12 via the elastic contact 13. The elastic contact 13 is an integral stamped part.

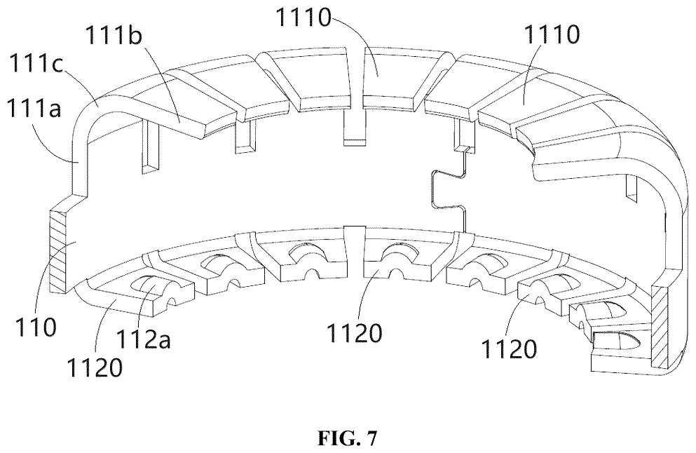

As shown in FIG. 7, the elastic part 111 of the outer conductive shell 11 includes multiple elastic arms 1110, which are distributed at intervals in the circumferential direction of the outer conductive shell 11. One ends of the multiple elastic arms 1110 are connected to the upper periphery of the annular wall 110, and the other ends are axially pressed against the inner conductive body 12.

As shown in FIG. 7, each elastic arm 1110 includes a first arm 111a, a second arm 111c, and a third arm 111b. The first arm 111a extends axially and its lower end is connected to the upper periphery of the annular wall 110. The second arm 111c is arc-shaped and one end of it is connected to the upper end of the first arm 111a. The third arm 111b is connected to the other end of the second arm 111c and extends slightly downwards towards the center of the outer conductive shell 11. The end of the third arm 111b is axially pressed against the inner conductive body 12 to make electrical contact with it.

As shown in FIG. 7, the connection part 112 of the outer conductive shell 11 includes multiple connecting feet 1120, which are distributed at intervals in the circumferential direction of the outer conductive shell 11 and axially abut against the inner conductive body 12. The multiple connecting feet 1120 are connected to the lower periphery of the annular wall 110 and extend radially towards the center of the outer conductive shell 11.

As shown in FIG. 7, a contact protrusion 112a is formed on the top surface of each of the connecting feet 1120, and the contact protrusion 112a is in axial electrical contact with the inner conductive body 12 to electrically connect with the inner conductive body 12. The bottom surface of each of the connecting feet 1120 is suitable for being soldered onto a circuit board 2 for electrical connection with the circuit board 2.

As shown in FIG. 3, the inner conductive body 12 has axially opposite top and bottom surfaces, and the elastic part 111 of the outer conductive shell 11 is axially pressed against the top surface of the inner conductive body 12.

As shown in FIG. 3, the inner conductive body 12 includes an upper cylinder 121 and a lower cylinder 122 coaxially connected. As shown in FIGS. 3, and 6, the diameter of the upper cylinder 121 is larger than that of the lower cylinder 122, and the upper cylinder 121 is installed in the outer conductive shell 11. The elastic part 111 and the connection part 112 of the outer conductive shell 11 are axially pressed against the top and bottom surfaces of the upper cylinder 121, respectively, so that the upper cylinder 121 is axially clamped between the elastic part 111 and the connection part 112 of the outer conductive shell 11.

The bottom of the connection part 112 of the outer conductive shell 11 is adapted to be soldered to the circuit board 2. As shown in FIG. 2-3, the lower cylinder 122 of the inner conductive body 12 extends from the outer conductive shell 11 and is adapted to pass through the mounting hole 201 in the circuit board 2.

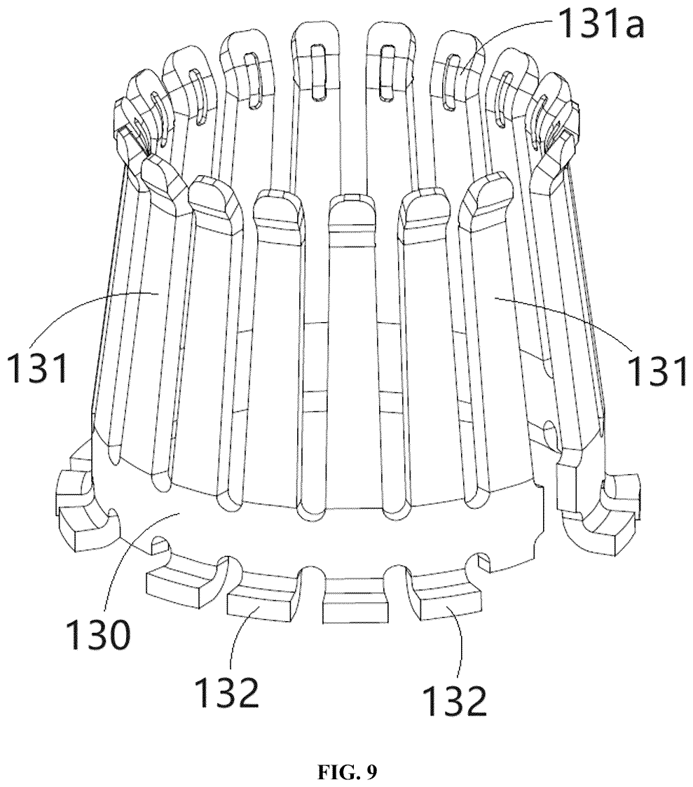

As shown in FIGS. 5 and 9, the elastic contact 13 includes a C-shaped ring 130 and multiple elastic contact arms 131. The multiple elastic contact arms 131 are connected to the upper side of the C-shaped ring 130 and distributed at intervals in the circumferential direction of the C-shaped ring 130. The multiple elastic contact arms 131 are used to make electrical contact with the outer peripheral surface of the mating plug 3 inserted into the inner cavity 120 of the inner conductive body 12.

As shown in FIGS. 5 and 9, the elastic contact 13 further includes multiple fixing feet 132, which are connected to the lower side of the C-shaped ring 130 and distributed at intervals in the circumferential direction of the C-shaped ring 130. A fixing groove 12a, as shown in FIGS. 6 and 8, is formed on the inner side of the lower end of the inner conductive body 12, and multiple fixing feet 132 are bent into an L shape and inserted and fixed into the fixing groove 12a.

The end portions 131a of the multiple elastic contact arms 131, as shown in FIGS. 5 and 9, are bent into an inwardly protruding arc shape for electrical contact with the outer peripheral surface of the mating plug 3 inserted into the inner cavity 120 of the inner conductive body 12.

As shown in FIGS. 6 and 8, a limit flange 12b is formed on the inner side of the upper end of the inner conductive body 12. The limit flange 12b is adapted to axially abut against the ends of the multiple elastic contact arms 131 to axially position the ends of the multiple elastic contact arms 131.

As shown in FIG. 6, the multiple elastic contact arms 131 extend obliquely towards the upper end and center of the inner conductive body 12, such that there is a predetermined angle between the multiple elastic contact arms 131 and the inner circumferential surface of the inner conductive body 12.

As shown in FIG. 5, the outer conductive shell 11 includes two half shells 11′ assembled together, and the half shell 11′ is an integral stamped part.

As shown in FIG. 5, the half shell 11′ includes a semi annular wall 110′. The semi annular walls 110′ of the two half shells 11′ are joined together to form an annular wall 110. As shown in FIG. 5, a dovetail shaped protrusion 11a and a dovetail shaped groove 11b are respectively formed at the joint ends of two semi annular walls 110′, and the dovetail shaped protrusion 11a is joined with the dovetail shaped groove 11b to join the two semi annular walls 110′ together. In other words, each semi annular wall 110′ has a first end and a second end, one semi annular wall 110′ has the dovetail shaped protrusion 11a formed on the first end and the dovetail shaped groove 11b formed on the second end, the other semi annular wall 110′ has the dovetail shaped protrusion 11a formed on the second end and the dovetail shaped groove 11b formed on the first end, the dovetail shaped protrusion 11a of the one semi annular wall 11′ is joined with the dovetail shaped groove 11b of the other semi annular wall 110′, and vice versa. The joining of the dovetail shaped protrusions 11a to the dovetail shaped grooves 11b joins the semi annular walls 110′ together.

In the aforementioned exemplary embodiments according to the present invention, the electrical connection assembly 1 achieves both axial and radial floating electrical contacts simultaneously. The electrical connection assembly 1 also has a very simple structure and is easy to manufacture.

An exemplary embodiment of an electrical connection product is now described with reference to FIGS. 1-10. The electrical connection product comprises the circuit board 2 and the aforementioned electrical connection assembly 1. The connection part 112 of the outer conductive shell 11 of the electrical connection assembly 1 is soldered to the circuit board 2.

An exemplary embodiment of a connector is now described with reference to FIGS. 1-10. The connector comprises an insulation housing, and the aforementioned electrical connection assembly 1. The electrical connection assembly 1 is installed in the insulation housing.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An electrical connection assembly, comprising:
an outer conductive shell having an annular wall with an upper periphery and a lower periphery axially opposite each other, an elastic part connected to the upper periphery, and a connection part connected to the lower periphery; and
an inner conductive body installed in the outer conductive shell and axially clamped between the elastic part and the connection part, an outer diameter of the inner conductive body is smaller than an inner diameter of the outer conductive shell, the inner conductive body floats axially and radially relative to the outer conductive shell and maintains electrical contact with the outer conductive shell.

2. The electrical connection assembly of claim 1, wherein a mating plug is inserted into an inner cavity formed in the inner conductive body, and the electrical connection assembly further comprises an elastic contact installed in the inner cavity, the elastic contact electrically contacts the mating plug and electrically connects the mating plug to the inner conductive body.

3. The electrical connection assembly of claim 2, wherein the elastic part has a plurality of elastic arms distributed at intervals in a circumferential direction of the outer conductive shell, one end of each elastic arm is connected to the upper periphery, and an other end of each elastic arm axially presses against the inner conductive body.

4. The electrical connection assembly of claim 3, wherein the elastic arm has a first arm extending axially and having a lower end connected to the upper periphery, a second arm having an arc-shape and one end connected to an upper end of the first arm, and a third arm connected to an other end of the second arm and extending downward towards a center of the outer conductive shell, an end of the third arm axially presses against the inner conductive body and electrically contacts the inner conductive body.

5. The electrical connection assembly of claim 4, wherein the connection part has a plurality of connecting feet distributed at intervals in the circumferential direction of the outer conductive shell, each of the connecting feet axially rest against the inner conductive body and are connected to the lower periphery and extend radially towards the center of the outer conductive shell.

6. The electrical connection assembly of claim 5, wherein a contact protrusion is formed on a top surface of each of the connecting feet, the contact protrusion is in axial electrical contact with and electrically connects to the inner conductive body, and a bottom surface of each of the connecting feet are soldered to and electrically connect to a circuit board.

7. The electrical connection assembly of claim 1, wherein the inner conductive body has a top surface and a bottom surface axially opposite each other, the elastic part axially presses against the top surface of the inner conductive body.

8. The electrical connection assembly of claim 7, wherein the inner conductive body has an upper cylinder and a lower cylinder coaxially connected, a diameter of the upper cylinder is larger than a diameter of the lower cylinder, the upper cylinder is installed in the outer conductive shell, and the elastic part and the connection part axially press against a top surface and a bottom surface of the upper cylinder, the upper cylinder is axially clamped between the elastic part and the connection part.

9. The electrical connection assembly of claim 8, wherein a bottom of the connection part is welded to a circuit board, and the lower cylinder extends out of the outer conductive shell and passes through a mounting hole in the circuit board.

10. The electrical connection assembly of claim 2, wherein the elastic contact has a C-shaped ring and a plurality of elastic contact arms, each elastic contact arm is connected to an upper side of the C-shaped ring and distributed at intervals in a circumferential direction of the C-shaped ring, each elastic contact arm electrically contacts an outer peripheral surface of the mating plug.

11. The electrical connection assembly of claim 10, wherein the elastic contact has a plurality of fixing feet each connected to a lower side of the C-shaped ring and distributed at intervals in the circumferential direction of the C-shaped ring, and a fixing groove is formed on an inner side of a lower end of the inner conductive body, the plurality of fixing feet are each bent into an L shape and inserted into and fixed in the fixing groove.

12. The electrical connection assembly of claim 10, wherein an end of each elastic contact arm is bent into an inwardly protruding arc shape, the end electrically contacts the outer peripheral surface of the mating plug.

13. The electrical connection assembly of claim 12, wherein a limit flange is formed on an inner side of an upper end of the inner conductive body, the limit flange axially abuts and axially positions each end of each elastic contact arm.

14. The electrical connection assembly of claim 10, wherein each elastic contact arm extends obliquely towards an upper end and a center of the inner conductive body such that there is a predetermined angle between the plurality of elastic contact arms and an inner circumferential surface of the inner conductive body.

15. The electrical connection assembly of claim 1, wherein the inner conductive body is an integral machined part.

16. The electrical connection assembly of claim 1, wherein the outer conductive shell has two half shells assembled together, each half shell is an integral stamped part.

17. The electrical connection assembly of claim 16, wherein each half shell has a semi annular wall, each semi annular wall of each half shell are joined together to form the annular wall, each semi annular wall has a first end and a second end, one semi annular has a dovetail shaped protrusion formed on the first end and a dovetail shaped groove formed on the second end, an other semi annular wall has the dovetail shaped protrusion formed on the second end and the dovetail shaped groove formed on the first end, the dovetail shaped protrusion of the one semi annular wall is joined with the dovetail shaped groove of the other semi annular wall joining the semi annular walls together.

18. The electrical connection assembly of claim 2, wherein the elastic contact is an integral stamped part.

19. An electrical connection product, comprising:
a circuit board; and
an electrical connection assembly including an outer conductive shell and an inner conductive body, the outer conductive shell has an annular wall with an upper periphery and a lower periphery axially opposite each other, an elastic part connected to the upper periphery, and a connection part connected to the lower periphery, the inner conductive body is installed in the outer conductive shell and axially clamped between the elastic part and the connection part, an outer diameter of the inner conductive body is smaller than an inner diameter of the outer conductive shell, the inner conductive body floats axially and radially relative to the outer conductive shell and maintains electrical contact with the outer conductive shell, the connection part is soldered to the circuit board.

20. A connector, comprising:
an insulation housing; and
an electrical connection assembly including an outer conductive shell and an inner conductive body, the outer conductive shell has an annular wall with an upper periphery and a lower periphery axially opposite each other, an elastic part connected to the upper periphery, and a connection part connected to the lower periphery, the inner conductive body is installed in the outer conductive shell and axially clamped between the elastic part and the connection part, an outer diameter of the inner conductive body is smaller than an inner diameter of the outer conductive shell, the inner conductive body floats axially and radially relative to the outer conductive shell and maintains electrical contact with the outer conductive shell, the electrical connection assembly is installed in the insulation housing.
